(19) United States
(12) Patent Application Publication
(10) Pub. No.: US 2016/0372979 A1
(43) Pub. Date: Dec. 22, 2016

(54) WIRELESS POWER SUPPLYING APPARATUS

(71) Applicant: MURATA MANUFACTURING CO., LTD., Kyoto-fu (JP)

(72) Inventor: Fumio YOSHIDA, Nagaokakyo-shi (JP)

(73) Assignee: MURATA MANUFACTURING CO., LTD., Kyoto-fu (JP)

(21) Appl. No.: 15/254,513

(22) Filed: Sep. 1, 2016

Related U.S. Application Data
(63) Continuation of application No. PCT/JP2015/057248, filed on Mar. 12, 2015.

(30) Foreign Application Priority Data
Mar. 14, 2014 (JP) 2014-052127

(51) Int. Cl. H02J 50/12; H01F 38/14

(52) U.S. Cl. CPC H02J 50/12; H01F 38/14

(57) ABSTRACT

A wireless power supplying apparatus that supplies power to a power receiving apparatus spatially separated from the wireless power supplying apparatus by using a magnetic field, includes a loop conductor for supplying power that is formed on a substrate made of an insulator and that includes inductance; an inverter circuit that receives a DC voltage, converts the DC voltage into an AC voltage, and applies the AC voltage to the loop conductor; and a capacitor connected between one end of the loop conductor and at least one end of the inverter circuit. The loop conductor surrounds a periphery of a power supplying area within a surface of the substrate, at least part of the loop conductor includes an indented portion that is indented from the periphery, and the loop conductor has a total length longer than a peripheral length of the power supplying area.

### CROSS REFERENCE TO RELATED APPLICATION

This application claims benefit of priority to Japanese Patent Application 2014-052127 filed Mar. 14, 2014, and to International Patent Application No. PCT/JP2015/057248 filed Mar. 12, 2015, the entire content of which is incorporated herein by reference.

### TECHNICAL FIELD

The present disclosure relates to a wireless power supplying apparatus in which power is supplied to a power receiving apparatus in a wireless way.

### BACKGROUND

In recent years, in accordance with the expansion of short-distance wireless communication systems, there have been an increasing number of cases in which various apparatuses have been independently used in a wireless manner. Accordingly, a technology of wireless power supply over a short distance has been noted, also in the area of power.

As documents regarding short-distance wireless communication systems, Japanese Unexamined Patent Application Publication No. 2006-180043 discloses a wireless IC tag using a planar antenna having a folded-back shape in a loop antenna structure, and Japanese Unexamined Patent Application Publication No. 2005-223402 discloses a wireless communication antenna which is devised so as to eliminate an area where communication is not possible, irrespective of the attitude of a communication target.

On the other hand, pamphlet on International Publication No. 2013/054399 as a document regarding short-distance power supply discloses the configuration of a power transmission system that facilitates the positional matching of the power transmitting unit of a power transmitting apparatus and the power receiving unit of a power receiving apparatus by arranging in sequence a plurality of coils that are partially superposed with one another.

### SUMMARY

### Technical Problem

The basic configuration of a wireless power supplying system which performs wireless power supply by using magnetic field coupling is a configuration where a loop conductor is provided on each of a power supplying apparatus side and a power receiving apparatus side and the loop conductors are made to be close to each other so as to have a relationship in which magnetic flux passes through each of the loops. Wireless power supply can be performed by causing magnetic field coupling with a specific coupling coefficient to be generated in the case where the positional relationship between the power transmitting unit of the power transmitting apparatus and the power receiving unit of the power receiving apparatus is fixed; however, in the case where power needs to be transmitted even when the position of the power receiving unit varies with respect to the power transmitting unit, the loop conductor of the power transmitting unit is to be made to be larger than the loop conductor of the power receiving unit.

However, as the diameter of the loop opening of the loop conductor of the power transmitting unit is increased, the magnetic field strength distribution within the loop opening becomes non-uniform. In other words, the magnetic field becomes weaker toward the center of the loop opening. Hence, the coupling coefficient changes in accordance with the position of the power receiving unit in the loop opening of the loop conductor of the power transmitting unit, resulting in unstable power supply. This problem is not solved by the structures illustrated in Japanese Unexamined Patent Application Publication No. 2006-180043, Japanese Unexamined Patent Application Publication No. 2005-223402, and pamphlet on International Publication No. 2013/054399.

It is an object of the present disclosure to provide a wireless power supplying apparatus that allows power supplied to a power transmitting unit to be stabilized even when the position of the power receiving unit is changed.

### Solution to Problem

The present disclosure provides a wireless power supplying apparatus that supplies, by using a magnetic field, power to a power receiving apparatus spatially separated from the wireless power supplying apparatus. The wireless power supplying apparatus includes: a loop conductor for supplying power that is formed on a substrate made of an insulator and that includes inductance; an inverter circuit that receives a DC voltage, converts the DC voltage into an AC voltage, and applies the AC voltage to the loop conductor; and a capacitor connected between one end of the loop conductor and at least one end of the inverter circuit. The loop conductor surrounds a periphery of a power supplying area within a surface of the substrate, at least part of the loop conductor includes an indented portion that is indented from the periphery, and the loop conductor has a total length longer than a peripheral length of the power supplying area. The wireless power supplying apparatus supplies power supplied from the inverter circuit to the power receiving apparatus by using a magnetic field generated by a current flowing through the loop conductor.

With this configuration, the distribution of magnetic field strength within a power supplying area based on the loop conductor forming area is made to be comparatively uniform, and supplied power is stabilized even when the position of the power receiving apparatus is changed.

Preferably, the loop conductor has a meandering shape, and a distance between parallel conductors that are parts of the loop conductor is larger than a width of the conductor. With this configuration, the distance between neighboring conductor patterns becomes relatively large, a substantial opening area through which magnetic flux passes is widened, and the coupling coefficient of coupling with the loop conductor of the power receiving apparatus is increased.

Preferably, the loop conductor includes a first meandering portion and a second meandering portion, the first meandering portion is formed of a combination of first long-path portions and first short-path portions, the second meandering portion is formed of a combination of second long-path portions and second short-path portions, and among the first long-path portions and the second long-path portions, a first long-path portion and a second long-path portion through which currents respectively flow in the same direction are adjacent to each other. With this configuration, generated magnetic flux per unit of current can be increased.

Preferably, at least portions of the first short-path portion or the second short-path portion, or at least portions of the first long-path portion or the second long-path portion are formed on surfaces of the substrate different from each other. With this configuration, crossing of conductor patterns on the same surface of the substrate can be avoided, and it becomes easy to form conductor patterns.

Preferably, the first long-path portion and the second long-path portion have the same length. This will allow the magnetic field strength distribution to be more uniform.

### Advantageous Effects of Disclosure

According to the present disclosure, the distribution of magnetic field strength within a power supplying area based on the loop conductor forming area becomes comparatively uniform, and supplied power is stabilized even when the position of the power receiving apparatus is changed.

### BRIEF DESCRIPTION OF DRAWINGS

FIG. 1(A) is a configuration diagram of a wireless power supplying apparatus according to a first embodiment, and

FIG. 1(B) is a diagram illustrating a positional relationship between a power receiving antenna and the wireless power supplying apparatus.

FIG. 2 is a diagram illustrating the configuration of an inverter circuit 13.

FIG. 3(A), FIG. 3(B), and FIG. 3(C) are configuration diagrams of other wireless power supplying apparatuses of the first embodiment.

FIG. 4 is a configuration diagram of a wireless power supplying apparatus 102 according to a second embodiment.

FIG. 5(A) is a plan view illustrating coupling between a portion of the meandering portion of a loop conductor 11 and a power receiving antenna and FIG. 5(B) is a front view.

FIG. 6(A) is another plan view illustrating coupling between a portion of the meandering portion of the loop conductor 11 and the power receiving antenna and FIG. 6(B) is a front view.

FIG. 7(A), FIG. 7(B), and FIG. 7(C) are diagrams each illustrating the relationship between the pitch in the power supplying loop conductor 11 and the size of the loop conductor of the power receiving antenna.

FIG. 8 is a diagram illustrating the shape of the loop conductor of a wireless power supplying apparatus according to a third embodiment.

FIG. 9 is a configuration diagram of a wireless power supplying apparatus 104 according to a fourth embodiment.

FIG. 10(A) is a plan view illustrating coupling between a power receiving antenna and a portion of the meandering portion of a loop conductor 11. FIG. 10(B) is a front view illustrating the coupling between the power receiving antenna and the portion of the meandering portion.

### DESCRIPTION OF EMBODIMENTS

The present disclosure is preferable for a system in which freedom in position is required on a plane, as in the case of a mouse and a pad, for example. In the embodiments described below, when wireless power supply to a mouse is performed, a wireless power supplying apparatus is provided, for example, on a mouse pad, and a power receiving antenna is provided, for example, on the mouse.

### First embodiment

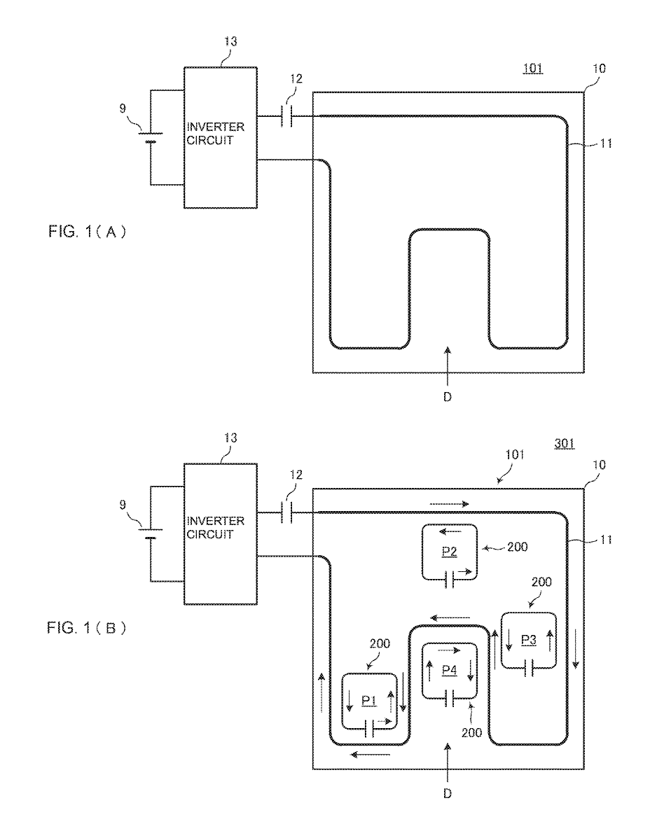

FIG. 1(A) is a configuration diagram of a wireless power supplying apparatus according to a first embodiment, and FIG. 1(B) is a diagram illustrating a positional relationship between a power receiving antenna and the wireless power supplying apparatus.

The wireless power supplying apparatus of the present embodiment is an apparatus that supplies power, by using a magnetic field, to a power receiving apparatus that is spatially separated therefrom. As illustrated in FIG. 1(A), a wireless power supplying apparatus 101 includes a substrate 10 formed of an insulator on which a loop conductor 11 for supplying power is formed, an inverter circuit 13 that receives a DC voltage and converts it into an AC voltage, and a capacitor 12. The capacitor 12 is connected between one end of the loop conductor 11 and one end of the inverter circuit 13.

The loop conductor 11 surrounds the periphery of a power supplying area within the surface of the substrate 10. Part of the loop conductor 11 has an indented portion D which is indented from the periphery, and the loop conductor 11 has a total length longer than the peripheral length of the power supplying area. In the loop conductor 11, each distance between parallel conductors is larger than the width of the conductors.

The loop conductor 11 has inductance, and an LC resonant circuit that resonates due to this inductance and the capacitance of the capacitor 12 is formed. The inverter circuit 13 receives a DC voltage of a DC power supply 9 and supplies a high-frequency current having a frequency that is the same as the resonant frequency of the LC resonant circuit. As a result, a magnetic field is generated by a current flowing through the loop conductor 11.

In FIG. 1(B), a plurality of power receiving antennas 200 are illustrated to show the positions where the power receiving antenna 200 is mounted on the wireless power supplying apparatus 101. When the power receiving antenna 200 is located at a position P1, a current indicated by the arrows is induced in the power receiving antenna 200 due to a magnetic field caused by a current flowing through the power supplying loop conductor 11 near this power receiving antenna 200. Also when the power receiving antenna 200 is located at a position P2 or P3, similarly, a current indicated by the arrows is induced in the power receiving antenna 200 due to a magnetic field caused by a current flowing through the power supplying loop conductor near the power receiving antenna 200. When the power receiving antenna 200 is located at a position P4, the power receiving antenna 200 is topologically located outside of the loop conductor 11. However, also at this position, a current indicated by the arrows is induced in the power receiving antenna 200 due to a magnetic field caused by a current flowing through the power supplying loop conductor 11 near the power receiving antenna 200.

In this way, as a result of the indented portion D being formed in the loop conductor 11, the magnetic field strength within the power supplying area (area around the outside of the loop conductor 11) is made to be uniform. When the power receiving antenna 200 is within the power supplying area of the wireless power supplying apparatus 101, power is supplied from the wireless power supplying apparatus 101 to the power receiving antenna 200.

Note that when the power receiving antenna 200 is on the conductor pattern of the power supplying loop conductor 11 and the conductor pattern of the power supplying loop conductor is arranged so as to halve the loop conductor of the power receiving antenna 200, pieces of magnetic flux passing through the loop conductor of the power receiving antenna 200 in opposite directions cancel out currents induced in the loop conductor of the power receiving antenna 200. However, few positions within the power supplying area satisfy such a condition.

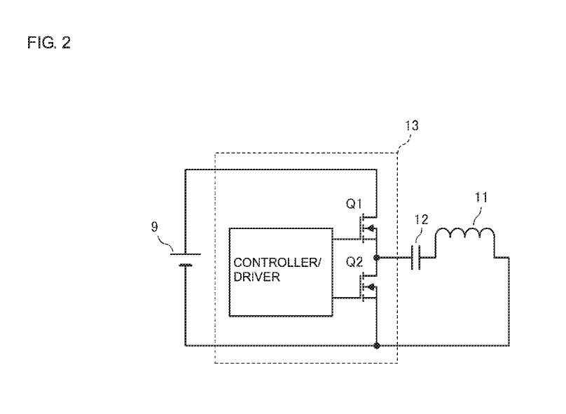

FIG. 2 is a diagram illustrating the configuration of the inverter circuit 13 described above. Here, the circuit of the whole wireless power supplying apparatus is illustrated. The inverter circuit 13 includes a high-side switch Q1, a low-side switch Q2, and a controller/driver circuit performing on/off control of these switches. The controller/driver circuit alternately turns the high-side switch Q1 and the low-side switch Q2 on/off at the resonant frequency of the above-described LC resonant circuit. As a result, a resonant inverter circuit is formed.

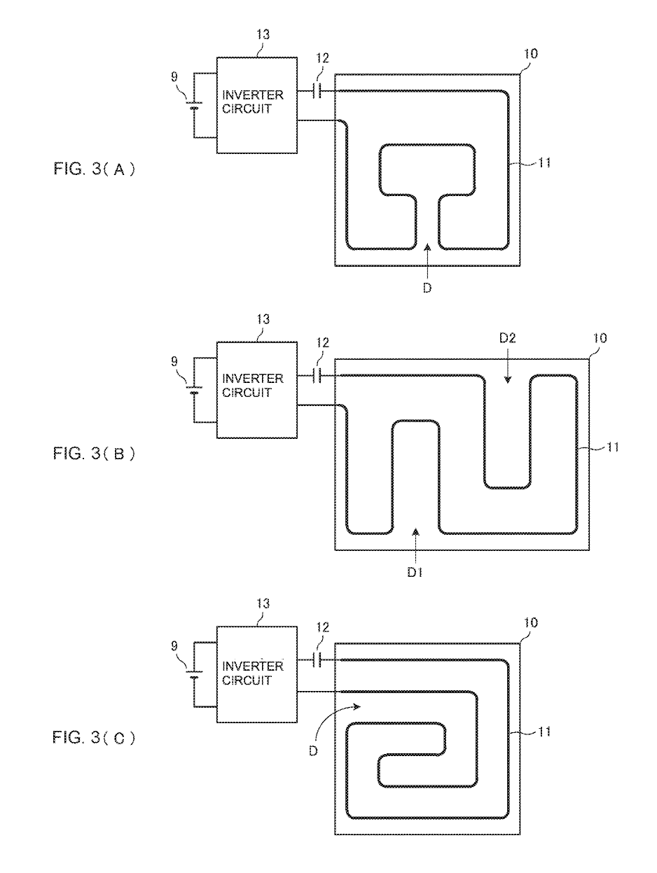

FIGS. 3(A), 3(B), and 3(C) are configuration diagrams of other wireless power supplying apparatuses of the first embodiment. In the example of FIG. 3(A), the innermost portion of the indented portion D of the loop conductor 11 for supplying power is widened. The indented portion D may have such a shape. In the example of FIG. 3(B), two indented portions D1 and D2 are formed in the loop conductor 11 for supplying power. In this way, a plurality of the indented portions may be provided. In the example of FIG. 3(C), the innermost portion of the indented portion D of the loop conductor 11 for supplying power spirals or meanders. Even with such shapes, the magnetic field strength within the power supplying area is made to be uniform since the space between the conductor patterns neighboring each other in the loop conductor 11 is not widened too much.

### Second embodiment

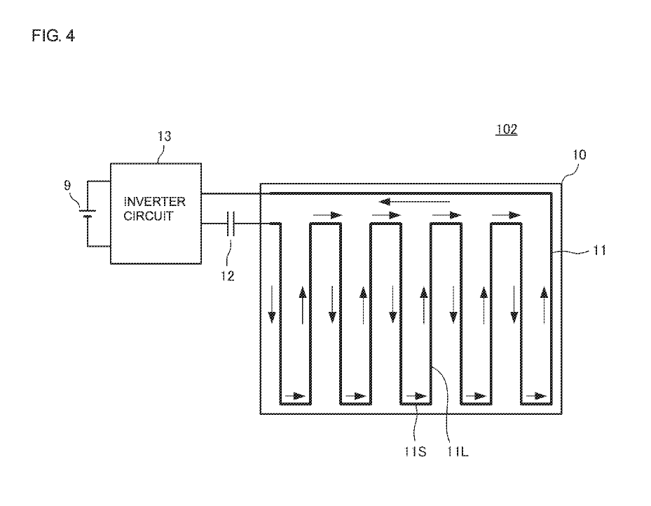

FIG. 4 is a configuration diagram of a wireless power supplying apparatus 102 according to a second embodiment. The wireless power supplying apparatus 102 includes a substrate 10 formed of an insulator on which a loop conductor 11 for supplying power is formed. As illustrated in FIG. 4, the loop conductor 11 includes a meandering portion. The rest of the configuration is the same as that described in the first embodiment.

The meandering portion of the power supplying loop conductor 11 described above is formed of a combination of long-path portions 11L and short-path portions 11S.

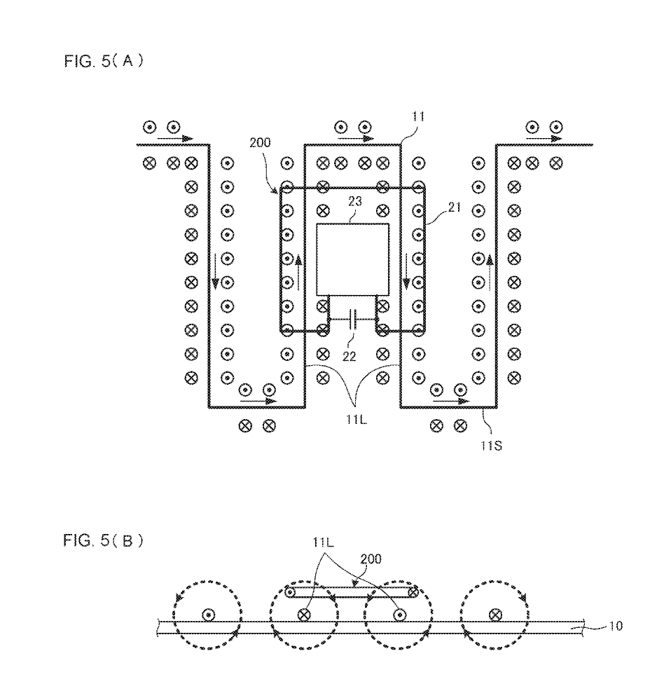

FIG. 5(A) is a plan view illustrating the coupling between a portion of the meandering portion of the loop conductor 11 described above and a power receiving antenna. FIG. 5(B) is the front view.

The power receiving antenna 200 is formed of a power receiving loop conductor 21, a capacitor 22, and a power receiving circuit 23. The power receiving loop conductor 21 and the capacitor 22 form an LC resonant circuit, and its resonant frequency is the same as the driving frequency of the inverter circuit 13 and the resonant frequency of an LC resonant circuit on the power supplying apparatus side. In FIG. 5(A), the x symbols and the dot symbols represent the directions of a magnetic field generated by a current flowing through the power supplying loop conductor 11. In this example, two of the long-path portions 11L are within the coil opening formed by the power receiving loop conductor 21 of the power receiving antenna 200, in plan view. Hence, the power receiving loop conductor 21 links with and is strongly coupled to magnetic flux generated by the two long-path portions 11L.

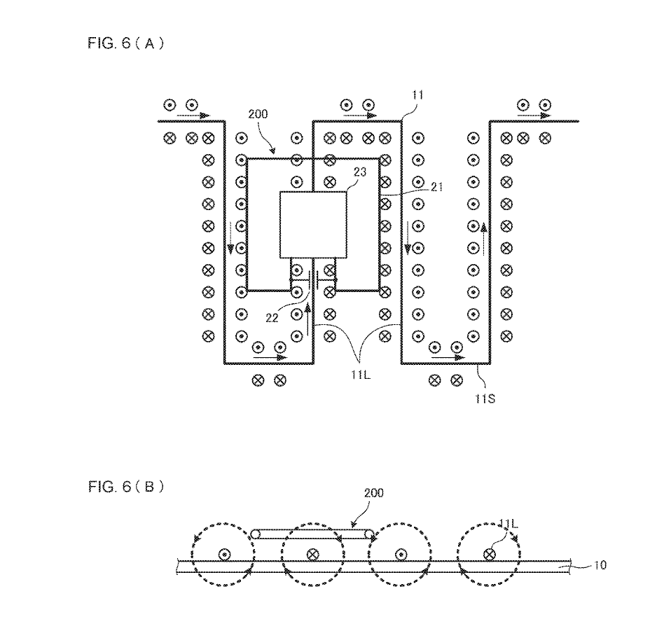

FIG. 6(A) is another plan view illustrating the coupling between a portion of the meandering portion of the loop conductor 11 described above and a power receiving antenna. FIG. 6(B) is the front view. In this example, the power receiving antenna 200 is arranged such that the center of the power receiving loop conductor 21 is superposed with a long-path portion 11L. Hence, currents induced in the loop conductor of the power receiving antenna 200 by pieces of magnetic flux passing through the loop conductor of the power receiving antenna 200 in opposite directions cancel each other out. However, there are few positions where a complete cancelling out condition is satisfied as in this example.

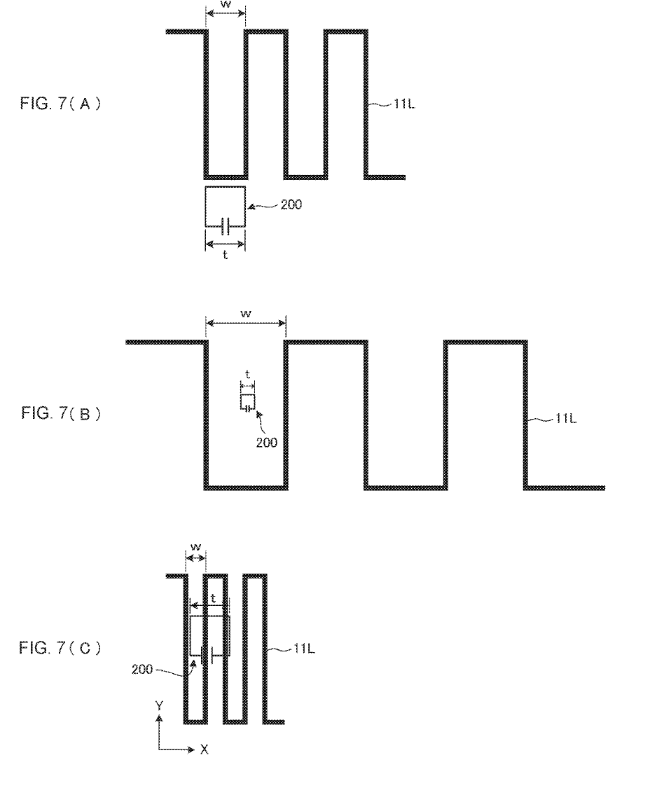

FIGS. 7(A), 7(B), and 7(C) are diagrams illustrating the relationship between the pitch in the power supplying loop conductor 11 and the size of the loop conductor of the power receiving antenna. In FIGS. 7(A), 7(B), and 7(C), when the pitch of the long-path portions 11L of the power supplying loop conductor 11 is w, and the width of the power receiving loop conductor of the power receiving antenna 200 is t, FIG. 7(A) illustrates an example where t=w, FIG. 7(B) illustrates an example where t<w, and FIG. 7(C) illustrates an example where t=2w. In the case of the relationship of FIG. 7(A), the coupling coefficient becomes the highest in a state where two of the long-path portions 11L are superposed with two sides of the power receiving loop conductors of the power receiving antenna. In the case of the relationship in FIG. 7(C), regardless of the location of the power receiving antenna 200 in the X-axis direction, pieces of magnetic flux that link with the opening of the power receiving loop conductor of the power receiving antenna have the same amount with positive and negative directions and, hence, the coupling coefficient becomes zero. This is the case also when t>2w. With the relationship of FIG. 7(B), the coupling coefficient is small compared with FIG. 7(A). Hence, the pitch of the long-path portions 11L of the meandering portion is set so as to satisfy the relationship w≦t<2w.

### Third embodiment

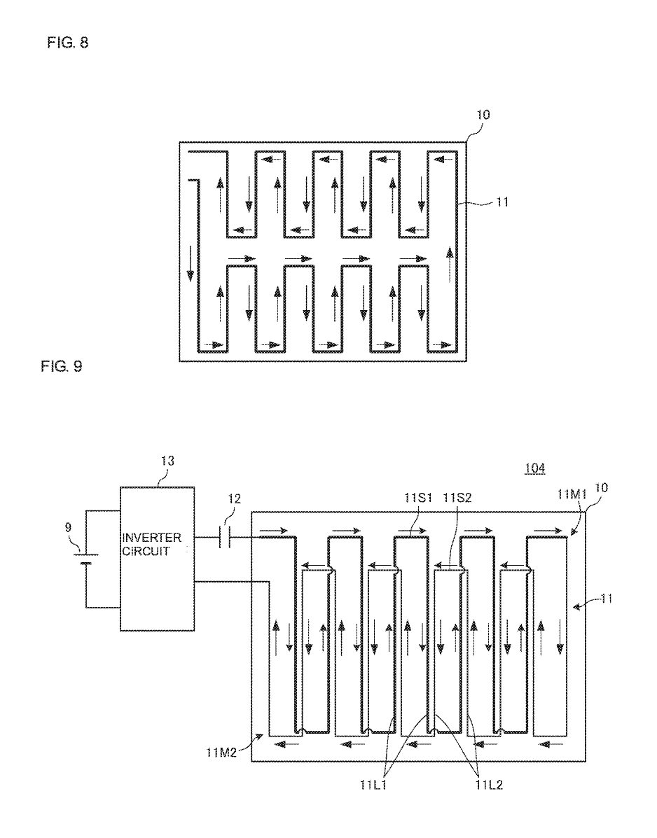

FIG. 8 is a diagram illustrating the shape of the loop conductor of a wireless power supplying apparatus according to a third embodiment. The loop conductor 11 includes a meandering portion which is folded back at the center. In this way, meandering portions may be formed at a plurality of positions.

### Fourth embodiment

FIG. 9 is a configuration diagram of a wireless power supplying apparatus 104 according to a fourth embodiment. The pattern of a power supplying loop conductor 11 has a meandering shape, but is different from the pattern illustrated in FIG. 4.

The loop conductor 11 includes a first meandering portion 11M1 and a second meandering portion 11M2. The first meandering portion 11M1 is formed of a combination of first long-path portions 11L1 and first short-path portions 11S1, and the second meandering portion 11M2 is formed of a combination of second long-path portions 11L2 and second short-path portions 11S2. As illustrated by arrows in FIG. 9, the long-path portions where currents having the same direction flow, among the first long-path portions 11L1 and the second long-path portions 11L2, are in the vicinity of one another. With this configuration, generated magnetic flux per unit of current can be increased. The first long-path portions 11L1 and the second long-path portions 11L2 have the same length. As a result, an area with uniform magnetic field strength distribution is widened.

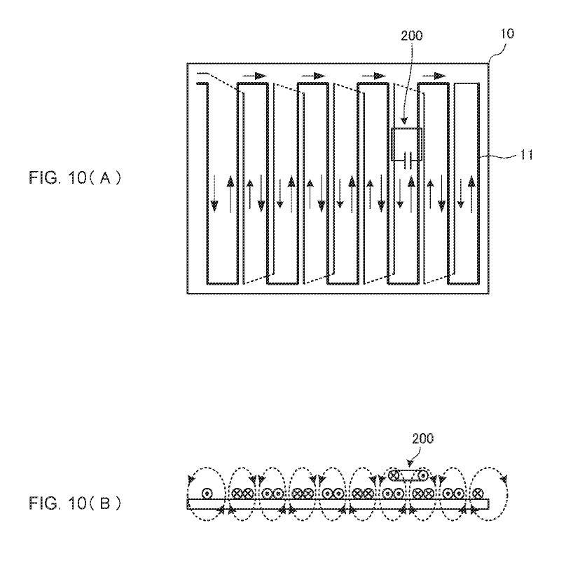

FIG. 10(A) is a plan view illustrating coupling between a power receiving antenna and a portion of the meandering portion of the loop conductor 11 described above. FIG. 10(B) is the front view.

In FIG. 10(B), the x symbols and the dot symbols represent the directions of a magnetic field generated by a current flowing through the power supplying loop conductor 11. In this example, a space between a set of the two long-path portions 11L1 and 11L2 and a neighboring set of the two long-path portions 11L1 and 11L2 is superposed with a coil opening formed by the power receiving loop conductor 21 of the power receiving antenna 200, in plan view. Hence, the power receiving loop conductor 21 links with and is strongly coupled to magnetic flux generated by the four long-path portions 11L.

Note that portions of the short-path portions are formed on surfaces of the substrate 10 different from each other, as illustrated in FIG. 10(A). With this configuration, crossing of conductor patterns on the same surface of the substrate can be avoided, and it becomes easy to form conductor patterns. Similarly, portions of the long-path portions may be formed on surfaces of the substrate 10 different from each other.

1. A wireless power supplying apparatus that supplies, by using a magnetic field, power to a power receiving apparatus spatially separated from the wireless power supplying apparatus, comprising:
a loop conductor for supplying power that is formed on a substrate made of an insulator and that includes inductance;
an inverter circuit that receives a DC voltage, converts the DC voltage into an AC voltage, and applies the AC voltage to the loop conductor; and
a capacitor connected between one end of the loop conductor and at least one end of the inverter circuit,
wherein the loop conductor surrounds a periphery of a power supplying area within a surface of the substrate, at least part of the loop conductor includes an indented portion that is indented from the periphery, and the loop conductor has a total length longer than a peripheral length of the power supplying area, and
wherein the wireless power supplying apparatus supplies power supplied from the inverter circuit to the power receiving apparatus by using a magnetic field generated by a current flowing through the loop conductor.

2. The wireless power supplying apparatus according to claim 1,
wherein the loop conductor has a meandering shape, and
wherein a distance between parallel conductors that are parts of the loop conductor is larger than a width of the conductor.

3. The wireless power supplying apparatus according to claim 2,
wherein the loop conductor includes a first meandering portion and a second meandering portion,
wherein the first meandering portion is formed of a combination of first long-path portions and first short-path portions,
wherein the second meandering portion is formed of a combination of second long-path portions and second short-path portions, and
wherein among the first long-path portions and the second long-path portions, a first long-path portion and a second long-path portion through which currents respectively flow in the same direction are adjacent to each other.

4. The wireless power supplying apparatus according to claim 3,
wherein at least portions of the first short-path portions or the second short-path portions, or at least portions of the first long-path portions or the second long-path portions are formed on surfaces of the substrate different from each other.

5. The wireless power supplying apparatus according to claim 3,
wherein the first long-path portions and the second long-path portions have the same length.

6. The wireless power supplying apparatus according to claim 1,
wherein the power receiving apparatus includes a power receiving loop conductor, and
wherein, among conductors parallel to each other in the indented portion of the power supplying loop conductor, a distance between conductors through which opposite currents respectively flow is greater than the width of the power receiving loop conductor.
